(19) United States
(12) Patent Application Publication
(10) Pub. No.: US 2004/0265535 A1
(43) Pub. Date: Dec. 30, 2004

(54) Suspension ornament

(76) Inventor: Cheng-Tong Chen, Changhua Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/610,023

(22) Filed: Jun. 30, 2003

(51) Int. Cl. B32B 3/06

(52) U.S. Cl. 428/99; 428/13

(57) ABSTRACT

A suspension ornament includes a connecting seat, a decorative member, a suspension connector, a background decorative plate, and a locking bolt. Thus, the decorative member is integrally formed by a plastic molding process and is integrally formed with a spatial decorative body, thereby enhancing the aesthetic quality of the suspension ornament.

### BACKGROUND OF THE INVENTION

1. Field of the Invention

The present invention relates to a suspension ornament, and more particularly to a suspension ornament, wherein the decorative member is integrally formed by a plastic molding process and is integrally formed with a spatial decorative body, thereby greatly enhancing the aesthetic quality of the suspension ornament.

2. Description of the Related Art

A conventional suspension ornament comprises a connecting seat, a decorative member mounted on the connecting seat, and a suspension connector mounted on the decorative member, and a suspension member mounted on the suspension connector. The decorative member is made of metallic or ceramic material having a color or pattern to present an outstanding appearance. However, the color or pattern of the decorative member is tedious without variation, thereby decreasing the aesthetic quality of the conventional suspension ornament, so that the conventional suspension ornament cannot attract the consumer's attention or interest.

### SUMMARY OF THE INVENTION

The primary objective of the present invention is to provide a suspension ornament, wherein the decorative member is integrally formed by a plastic molding process and is integrally formed with a spatial decorative body, thereby enhancing the aesthetic quality of the suspension ornament.

Another objective of the present invention is to provide a suspension ornament, wherein the background decorative plate is a luminescent plate to provide an illumination effect for warning or indicating purposes.

A further objective of the present invention is to provide a suspension ornament, wherein the background decorative plate provides an illumination effect so as to enhance the spatial decorative effect of the spatial decorative body of the decorative member.

In accordance with the present invention, there is provided a suspension ornament, comprising:

a connecting seat; and

a decorative member mounted on the connecting seat;

wherein, the decorative member is integrally formed to have a preset shape and has an inside provided with a spatial decorative body, thereby enhancing the aesthetic quality of the suspension ornament.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a suspension ornament in accordance with the preferred embodiment of the present invention;

FIG. 2 is a perspective assembly view of the suspension ornament in accordance with the preferred embodiment of the present invention;

FIG. 3 is a side plan cross-sectional view of the suspension ornament as shown in FIG. 2; and

FIG. 4 is a schematic operational view of the suspension ornament as shown in FIG. 2 in use.

### DETAILED DESCRIPTION OF THE INVENTION

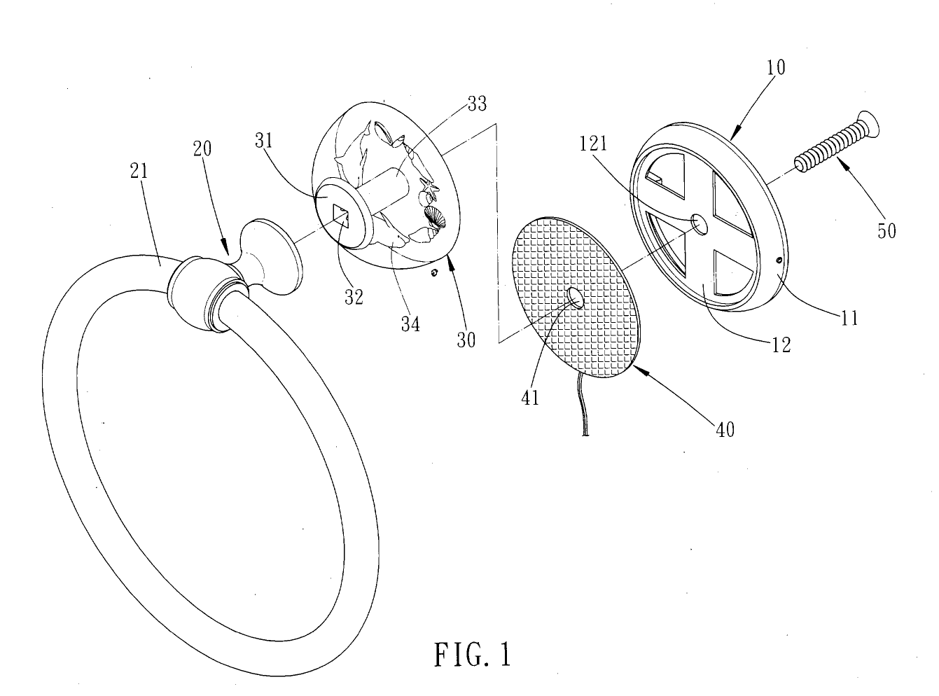

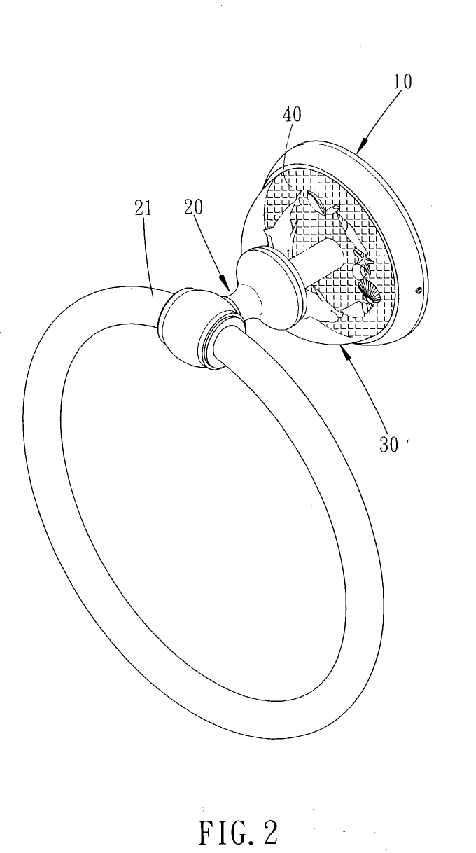

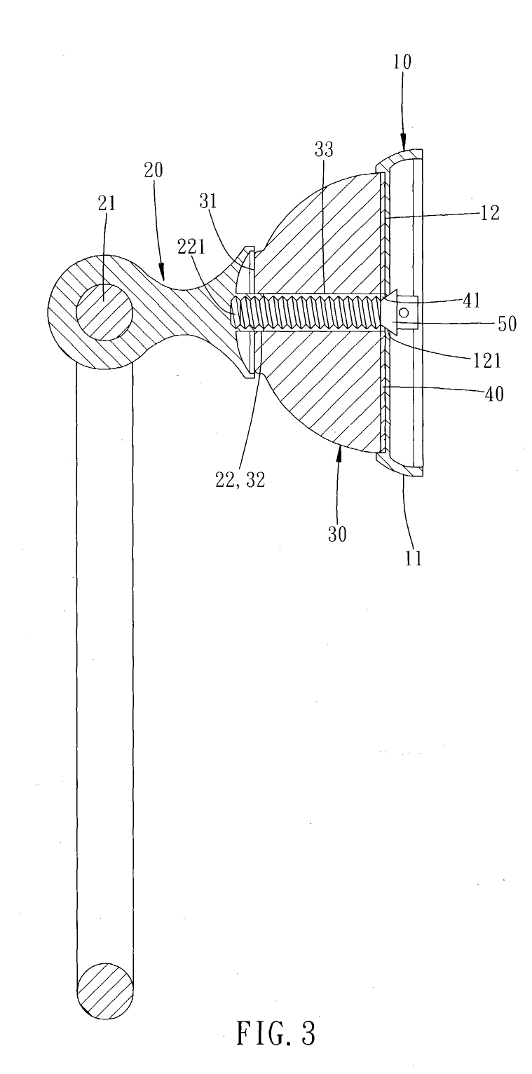

Referring to the drawings and initially to FIGS. 1-3, a suspension ornament in accordance with the preferred embodiment of the present invention comprises a connecting seat 10, a decorative member 30, a suspension connector 20 a background decorative plate 40, and a locking bolt 50.

The connecting seat 10 includes a ring 11 and a cruciform shaped support plate 12 mounted or integrally formed in the ring 11. The ring 11 of the connecting seat 10 has a cone-shaped periphery. The support plate 12 of the connecting seat 10 has a center formed with a through hole 121.

The decorative member 30 is mounted on the connecting seat 10 and has a first side rested on the support plate 12 of the connecting seat 10 and a second side formed with a flat face 31. The decorative member 30 is preferably made of transparent or translucent material. The decorative member 30 has an inside provided with a fixed or movable spatial decorative body 34. Preferably, the decorative member 30 is integrally formed by a plastic molding process to have a preset shape, and is integrally formed with the spatial decorative body 34, thereby enhancing the aesthetic quality of the suspension ornament. The decorative member 30 has a center formed with a circular hole 33. The flat face 31 of the decorative member 30 has a center formed with a square positioning hole 32 communicating with the circular hole 33 of the decorative member 30.

The suspension connector 20 is mounted on the decorative member 30 and has a first side rested on the flat face 31 of the decorative member 30 and a second side provided with a ring-shaped suspension member 21. The first side of the suspension connector 20 is provided with a square positioning stud 22 secured in the positioning hole 32 of the decorative member 30. The positioning stud 22 of the suspension connector 20 has an inside formed with a screw bore 221. Alternatively, the suspension connector 20 is integrally formed with the decorative member 30.

The background decorative plate 40 is mounted between the connecting seat 10 and the decorative member 30 and has a center formed with a through hole 41. Preferably, the background decorative plate 40 is mounted between the support plate 12 of the connecting seat 10 and the first side of the decorative member 30. Preferably, the background decorative plate 40 is a luminescent plate. Preferably, the background decorative plate 40 is provided with colorful patterns.

The locking bolt 50 is extended through the through hole 121 of the support plate 12 of the connecting seat 10, the through hole 41 of the background decorative plate 40 and the circular hole 33 of the decorative member 30 and is screwed into the screw bore 221 of the positioning stud 22 of the suspension connector 20, so that the connecting seat 10, the background decorative plate 40, the decorative member 30 and the suspension connector 20 are combined with each other integrally.

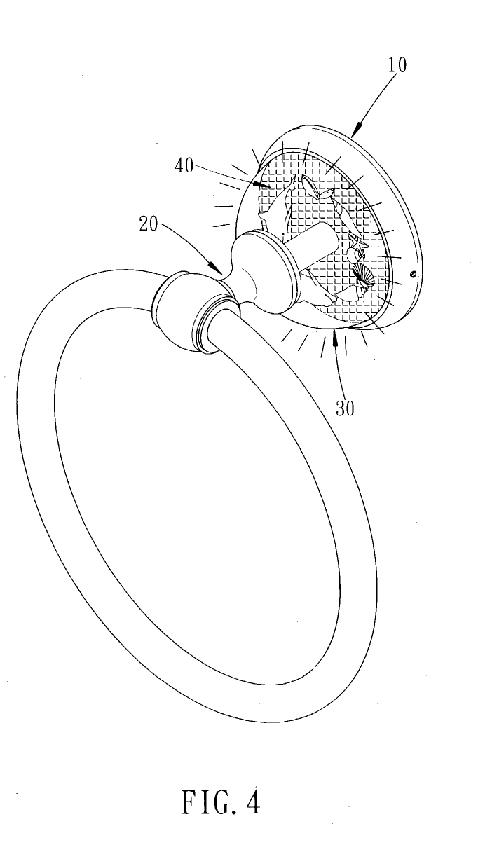

As shown in FIG. 4, the background decorative plate 40 is a luminescent plate to provide an illumination effect for warning or indicating purposes. In addition, the background decorative plate 40 provides an illumination effect so as to enhance the spatial decorative effect of the spatial decorative body 34 of the decorative member 30.

Accordingly, the suspension ornament in accordance with the preferred embodiment of the present invention has the following advantages.

1. The decorative member 30 is integrally formed by a plastic molding process and is provided with a spatial decorative body 34, thereby enhancing the aesthetic quality of the suspension ornament.

2. The background decorative plate 40 is a luminescent plate to provide an illumination effect for warning or indicating purposes.

3. The background decorative plate 40 provides an illumination effect so as to enhance the spatial decorative effect of the spatial decorative body 34 of the decorative member 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A suspension ornament, comprising:
a connecting seat; and
a decorative member mounted on the connecting seat;
wherein, the decorative member is integrally formed to have a preset shape and has an inside provided with a spatial decorative body, thereby enhancing the aesthetic quality of the suspension ornament.

2. The suspension ornament in accordance with claim 1, wherein the decorative member is made of transparent material.

3. The suspension ornament in accordance with claim 1, wherein the decorative member is made of translucent material.

4. The suspension ornament in accordance with claim 1, wherein the decorative member is integrally formed with the spatial decorative body.

5. The suspension ornament in accordance with claim 1, wherein the spatial decorative body of the decorative member is fixed.

6. The suspension ornament in accordance with claim 1, wherein the spatial decorative body of the decorative member is movable.

7. The suspension ornament in accordance with claim 1, wherein the decorative member has a first side rested on the connecting seat, and the suspension ornament further comprises a suspension connector mounted on the decorative member.

8. The suspension ornament in accordance with claim 7, wherein the decorative member has a second side formed with a flat face, and the suspension connector has a first side rested on the flat face of the decorative member.

9. The suspension ornament in accordance with claim 8, wherein the suspension connector has a second side provided with a ring-shaped suspension member.

10. The suspension ornament in accordance with claim 7, wherein the suspension connector is integrally formed with the decorative member.

11. The suspension ornament in accordance with claim 8, wherein the flat face of the decorative member has a center formed with a square positioning hole, the first side of the suspension connector is provided with a square positioning stud secured in the positioning hole of the decorative member.

12. The suspension ornament in accordance with claim 11, wherein the positioning stud of the suspension connector has an inside formed with a screw bore, the decorative member has a center formed with a circular hole communicating with the positioning hole, and the suspension ornament further comprises a locking bolt extended through the connecting seat and the circular hole of the decorative member and screwed into the screw bore of the positioning stud of the suspension connector.

13. The suspension ornament in accordance with claim 1, further comprising a background decorative plate mounted between the connecting seat and the decorative member.

14. The suspension ornament in accordance with claim 13, wherein the connecting seat includes a ring and a cruciform shaped support plate mounted in the ring, and the background decorative plate is mounted between the support plate of the connecting seat and the first side of the decorative member.

15. The suspension ornament in accordance with claim 14, wherein the ring 11 the connecting seat has a cone-shaped periphery.

16. The suspension ornament in accordance with claim 13, wherein the background decorative plate is a luminescent plate.

17. The suspension ornament in accordance with claim 13, wherein the background decorative plate is provided with colorful patterns.
